(19) United States
(12) Patent Application Publication
(10) Pub. No.: US 2014/0117847 A1
(43) Pub. Date: May 1, 2014

(54) GAS DISCHARGE LAMP AND AN ELECTRODE FOR A GAS DISCHARGE LAMP

(71) Applicants: Norbert Magg, Berlin (DE); Markus Stange, Berlin (DE)

(72) Inventors: Norbert Magg, Berlin (DE); Markus Stange, Berlin (DE)

(21) Appl. No.: 14/118,469

(22) PCT Filed: Apr. 16, 2012
(86) PCT No.: PCT/EP2012/056932

§ 371 Date: Nov. 18, 2013

(30) Foreign Application Priority Data
May 16, 2011 (DE) 10 2011 075 899.2

(51) Int. Cl. H01J 61/073

(52) U.S. Cl. CPC H01J 61/0732; H01J 61/0735
USPC 313/623; 313/354

(57) ABSTRACT

An electrode for a gas discharge lamp having a massive electrode head and an electrode rod connected thereto, which has a guide section which can be led through a wall of a discharge vessel of the gas discharge lamp or can be fused into said wall or can be encompassed by said wall. The grid structure of at least one section of the electrode rod has doping. At least one section of the electrode head consists of highly pure tungsten. A concentration of a contaminant is less than 10 ppm.

### TECHNICAL FIELD

The invention is based on an electrode according to the preamble of claim 1 or on a gas discharge lamp according to the preamble of claim 11.

A gas discharge lamp, which below is understood also to mean a high-pressure gas discharge lamp or extremely high-pressure gas discharge lamp, contains a pair of electrodes which preferably consist of tungsten. The higher the power or wattage of the gas discharge lamp, the greater and therefore also heavier are usually the electrodes preferably consisting of tungsten, in order that said electrodes can withstand the high current intensity associated with the high power and the high temperature resulting therefrom.

This applies in particular to the heads of the electrodes, at which the discharge arc is struck at mutually opposite end sections. An electrode head must withstand temperatures close to the melting point of tungsten in this area. Since, at these high temperatures, constituent parts of the electrode material which have a lower melting temperature than tungsten increasingly evaporate into the gas atmosphere of the discharge vessel, the highest possible purity, at least of the electrode head, is important in order to counteract deposition in the form of blackening of the discharge vessel and a reduced service life of the gas discharge lamp that is associated therewith.

An electrode rod or a guide section of the electrode rod at the other end section of each electrode head is fused with a glass matrix of the discharge vessel of the gas discharge lamp in a gas-tight manner in a suitable thermal process (e.g. fusing-in or pinching process). Here, quartz glass having a high temperature resistance is predominantly used. On account of very different expansion coefficients of the quartz glass and of the tungsten, stresses occur at the boundary layer of the fusing during the fusing or during operation of the gas discharge lamp, which can lead to cracks at the boundary layer between the electrode rod and glass matrix. In addition, during the fusing, voids remain between glass and electrode rod. Both phenomena—voids and cracks—can impair the stability and the tightness of the discharge vessel and are greater and more numerous, the greater a cross section or diameter of the electrode rod. For this reason, attempts are made to keep the cross section thereof as small as possible.

Because of the brittleness of highly pure tungsten, a combination of heavy electrode head and small electrode rod cross section leads to a reduced stability of the electrode, however, which represents a problem in particular in the case of high wattage lamps having a particularly large electrode head. A reduced stability can lead to increase fragility of the electrode rod or to bending of the electrode rod. The latter is observed in particular in the area of the fusing in the case of frequent switching cycles.

### PRIOR ART

The conflict between the stability of the electrode or the electrode rod and the stability of the discharge vessel is combated in the prior art with a compromise in the area of the fusing of the electrode rod into the discharge vessel. In the case of large electrode head diameters, adapted large electrode rod diameters are accordingly used.

In the case of electrodes for high-wattage gas discharge lamps which, for the aforementioned reasons, have a massive electrode head, the latter is preferably turned from a solid material, the diameter of which must correspond at least to a maximum diameter of the electrode head. The electrode rod is also turned out of the solid material in one piece with the electrode head, which leads to a considerable material loss on account of the material turned off the electrode rod, as soon as the electrode rod is thinner than the electrode head.

In order to minimize the material loss, it is known to join the electrode from two parts, which means that the two parts, the electrode head and the electrode rod, can be fabricated from semifinished products of different diameter.

For this purpose, WO 2007/138092 A2 shows a multipart electrode and a joining method for the fabrication thereof. The electrode has an electrode rod which is integrally connected to the electrode head via a resistance butt welding method or a press welding method. Although the material loss can be reduced in this way by using different semifinished products, the disadvantage with this solution is, furthermore, that, with increasing power of the gas discharge lamp for which the electrode is provided and the associated necessary size of the electrode, an electrode rod with increasingly large cross section is also necessary.

### SUMMARY OF THE INVENTION

The object of the present invention is, therefore, to provide an electrode with increased strength or a gas discharge lamp having an electrode with increased strength.

This object is achieved by an electrode according to claim 1 or a gas discharge lamp according to claim 11.

Particularly advantageous refinements will be found in the dependent claims.

An electrode according to the invention for a gas discharge lamp, in particular for a high-pressure or extremely high-pressure gas discharge lamp, has a massive electrode head and an electrode rod which is connected thereto, which has a guide section which can be guided through a wall of a discharge vessel of the gas discharge lamp or fused into said wall or encompassed by said wall. According to the invention, the structure of at least one section of the electrode rod or of the entire electrode rod is optimized in order to increase the strength of the electrode rod. The structure is a grid or crystal structure or a microstructure or a surface structure of the section or of the electrode rod.

This optimization of the structure makes it possible, with a given cross section of the optimized section or of the optimized electrode rod, to increase the strength thereof, in particular against plastic deformation or fracture or to reduce the cross section for the required strength. The optimization according to the invention of the structure permits diameter ratios of an electrode head diameter to an electrode rod diameter of about 5. By contrast, a diameter ratio of a conventional electrode without an optimized structure of the section or the electrode rod is only around 3.8. Thus, the strength of the section or the electrode rod and therefore the electrode is increased without any material reinforcement and without any additional device for reinforcement. On account of the multi-part nature of the electrode, the electrode head is not fabricated in one piece with the electrode rod but rather connected or joined; the structural optimization of the electrode rod can be carried out independently of the electrode head, which decisively facilitates mass fabrication of optimized electrode rods since, during optimization steps of the electrode rod, no measures have to be taken to protect or take care of the sensitive electrode head. For example, tumbling for the simultaneous rounding of edges of the multiplicity of electrode rods is made possible, which is associated with a considerable reduction in the expenditure on fabrication.

The electrode head is preferably connected to the electrode rod by means of welding or brazing, in particular by resistance butt welding, press butt welding, laser butt welding or friction welding.

An electrode rod of which the structure is optimized in this way, having increased strength with a predefined cross section, is in particular advantageous for a high-wattage gas discharge lamp with a power beginning at about 250 watts, since, in particular in this application, a large electrode head has to be held by the electrode rod and, at the same time, the latter should be as stable and thin as possible. The massive electrode head is preferably machined out of solid material via a material-removing method, for example by turning. It can additionally also be wound around with a wire filament.

In a preferred development, the grid structure preferably has doping with a dopant for the purpose of optimizing the same. In this way, in particular brittleness of the section of the electrode rod can be reduced and the strength thereof increased. In particular in a cold state of the electrode, fracture resistance of the electrode rod is thus increased, which, for example, minimizes transport damage to the electrode as a result of vibration.

The doping or the dopant preferably contains potassium.

In a preferred development, a concentration of the doping is at most 100 ppm, with the result that void formation in the area of a welded connection, by which the section is connected to the electrode head, is restricted. Particularly preferably, the concentration is at most 70 ppm.

Advantageously, the electrode rod consists predominantly of tungsten, since tungsten withstands well the temperature of the discharge arc that occurs. Given lower requirements on the temperature resistance, the electrode rod can alternatively consist predominantly of molybdenum.

In a further preferred development, the section and the guide section coincide physically, so that the structure of the electrode rod is optimized in a region in which the electrode rod or the guide section thereof can be led through the wall of the discharge vessel of the gas discharge lamp or fused into said wall or encompassed by said wall. This permits an increase in the strength of the electrode rod whilst taking into account the interaction of the guide section of the electrode rod with the wall of the discharge vessel. In this development, optimization of the surface structure with a texture, in particular, is advantageous.

It proves to be particularly advantageous if the surface structure or the texture of the section has an average roughness which is lower in the direction of the longitudinal axis of the section than transversely with respect to said direction. If the section and the guide section coincide physically, for example, it is possible to allow the electrode rod or the guide section thereof axial mobility in the area of the wall of the discharge vessel and to minimize shear or frictional stresses between the electrode rod and the discharge vessel, which leads to a reduced tendency to bending of the electrode rod and also to a reduced probability of failure of the discharge vessel.

In a preferred development, at least the guide section of the electrode rod, in a quite particularly preferred development the complete electrode rod, is fabricated from wire, in particular from drawn or from rolled wire. It is particularly advantageous in this case that, on account of the drawing or rolling, the microstructure of a radial outer region of the wire is more fine-grained or compacted than the microstructure of a radial inner region of the wire. This constitutes an optimized microstructure, by means of which the strength of the section or of the electrode rod is increased.

In a preferred development, effective optimization of the surface structure is provided if the latter has a multiplicity of longitudinal grooves running approximately parallel to the longitudinal axis of the section. In particular when wire is used to form the electrode rod, such a preferred surface structure can already be produced simply by drawing during the fabrication of the wire.

In order that the electrode withstands extremely high temperatures, and in order to increase the service life of the gas discharge lamp in which the electrode can be used, at least one section of the electrode head, in particular a section at which a discharge arc can be struck, consists of highly pure tungsten. A concentration of a contaminant of the tungsten is preferably less than 10 ppm, particularly preferably less than or equal to 5 ppm, quite particularly preferably less than or equal to 1 ppm, which, during operation of the electrode, results in a very low evaporation rate of electrode material and therefore to only minimal blackening of the discharge vessel. In addition, this increases the service life of the gas discharge lamp.

A gas discharge lamp according to the invention, in particular a high-pressure or extremely high-pressure gas discharge lamp, has a discharge vessel in which two electrodes are arranged approximately diametrically. At least one of the two electrodes has a massive electrode head and an electrode rod connected thereto, in particular integrally, for example by means of welding or brazing. Said electrode rod has a guide section, which is led through a wall of the discharge vessel or which is fused into said wall or which is encompassed by said wall. According to the invention, the structure of the electrode rod or at least one section of the electrode rod is optimized in order to increase the strength of the electrode rod. The structure is a grid or crystal structure or a micro structure or a surface structure of the section or of the electrode rod.

This optimization of the structure makes it possible, with a given cross section of the optimized section or of the optimized electrode rod, to increase the strength thereof, in particular against plastic deformation or fracture, or to reduce the cross section for a required strength. Thus, the strength of the section or of the electrode rod and therefore of the electrode is increased without any material reinforcement and without additional reinforcing device. On account of the multi-part nature of the electrode, the electrode head is not fabricated in one piece with the electrode rod and connected or joined; the structural optimization of the electrode rod can be carried out independently of the electrode head, which decisively facilitates mass fabrication of optimized electrode rods since, during optimization steps, no measures have to be taken to protect or take care of the sensitive electrode head. For example, tumbling for the simultaneous rounding of edges of the multiplicity of electrode rods is made possible, which is associated with a considerable reduction in the expenditure on fabrication. The electrode head is preferably connected to the electrode rod by means of welding or brazing, in particular by resistance butt welding, press butt welding, laser butt welding or friction welding. The gas discharge lamp preferably has a high wattage and preferably has powers beginning from about 250 watt.

In a preferred development of the gas discharge lamp, the grid or crystal structure of the electrode rod or the section thereof is optimized via doping with a dopant, so that, for example, brittleness of the electrode rod or of the section is reduced and fracture resistance is increased. In this case, the doping preferably has potassium. A concentration of the doping is preferably at most 100 ppm, particularly preferably at most 70 ppm. The electrode rod particularly preferably consists predominantly of tungsten but, as an alternative to this, for example in the event of lower requirements on the temperature resistance, can consist predominantly of molybdenum.

In a further preferred development of the gas discharge lamp, the microstructure is optimized in such a way that a structure of a radial outer region of the electrode rod or of the section is more fine-grained or compacted than a structure of a radial inner region of the electrode rod or of the section, as a result of which an increased edge hardness is made possible and a tendency of the electrode rod to bend under cyclic thermal loading, for example in the event of short switching cycles or frequent switching operations of the discharge lamp, is reduced.

In a further preferred development, the surface structure is optimized in such a way that an average roughness in the direction of a longitudinal axis of the section is lower than transversely with respect to said direction. This is particularly advantageous when the section coincides physically with the guide section and the latter is fused into the wall. In the event of thermal expansion of the guide section during operation of the gas discharge lamp, in this way the displacement of the surface of the guide section with respect to the wall of the discharge vessel is made easier and shear stress between the wall and the electrode rod on account of the different temperature expansion coefficients of the two materials is reduced. In a preferred development, the surface structure of the guide section has a multiplicity of longitudinal grooves running approximately parallel to the longitudinal axis of the guide section.

In an advantageous development, the guide section is encompassed by a sleeve or arranged in the latter and the sleeve is fused or inserted into the wall. In the sleeve, the guide section is supported by the surface thereof such that it can be displaced axially, which likewise reduces mechanical loading of the wall on account of shear stresses between the wall and the electrode rod. It is particularly advantageous if the surface structure of the guide section is provided with longitudinal grooves. As a result, groove peaks are preferably in contact with the inner circumferential surface of the sleeve, which further reduces shear stress between the electrode rod and the sleeve. The sleeve preferably consists predominantly of molybdenum which, even at high temperatures, permits no sintering with the guide section or with the electrode rod.

### BRIEF DESCRIPTION OF THE DRAWINGS

The invention is to be explained in more detail below by using three exemplary embodiments and eight schematic figures, in which:

FIG. 1 shows a schematic illustration of a first exemplary embodiment of an electrode having an optimized surface structure of an electrode rod in a lateral view;

FIG. 2 shows a schematic illustration of a second exemplary embodiment of the electrode having a grid structure of an electrode rod, optimized by doping, in a lateral view;

FIG. 3 shows a schematic micrograph of the electrode of the second exemplary embodiment according to FIG. 2;

FIG. 4 shows a schematic enlarged polished micrograph of the electrode of the second exemplary embodiment according to FIGS. 2 and 3;

FIG. 5 shows a schematic enlarged etched micrograph of the electrode of the second exemplary embodiment according to FIGS. 2 to 4;

FIG. 6 shows a schematic micrograph of an electrode of the third exemplary embodiment having an undoped electrode rod;

FIG. 7 shows a schematic enlarged polished micrograph of the electrode of the third exemplary embodiment according to FIG. 6; and

FIG. 8 shows a schematic enlarged etched micrograph of the electrode of the third exemplary embodiment according to FIGS. 6 and 7.

### PREFERRED EMBODIMENT OF THE INVENTION

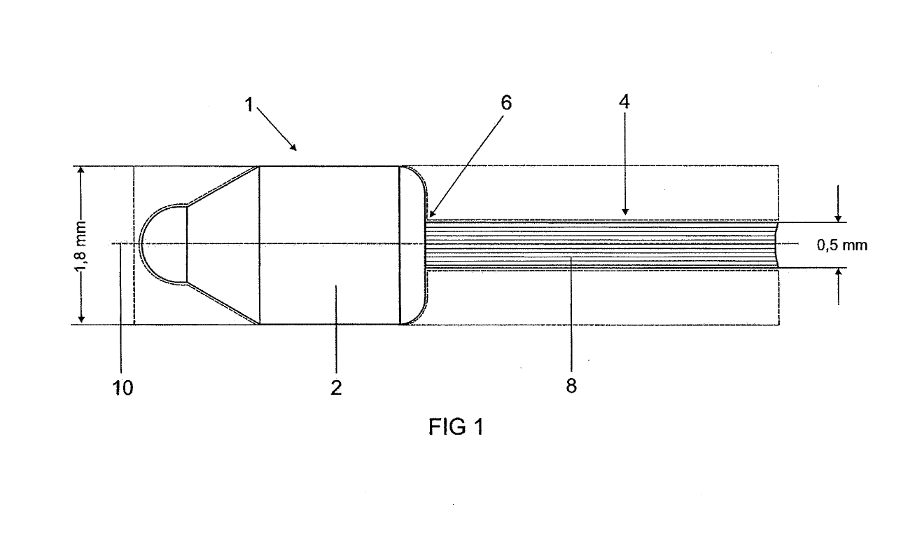

FIG. 1 shows a schematic illustration of a first exemplary embodiment of an electrode 1.

The electrode 1 has a massive electrode head 2 and also an electrode rod 4, which is fabricated from a wire drawn exactly to a necessary final diameter of the electrode rod 4. The semifinished product of the wire is fabricated from high-purity tungsten powder by means of a powder-metallurgical sintering method. The electrode 1 consists in its entirety of tungsten with a concentration of contaminants of less than 10 ppm. The electrode head 2 and the electrode rod 4 are joined via a butt welding method at a connection point 6.

As compared with a conventional single-part electrode which is turned out of a single piece of solid material, the use of the drawn wire for the electrode rod 4 has the particular advantage that, as a result of the drawing process, a microstructure in a radial edge region of the electrode rod 4 is optimized and a density is increased. In addition, as a result of the drawing, a microstructure of an inner region of the electrode rod 4 is optimized. As a result, the whole of the electrode rod 4 has an increased strength and, in relation to the size of the electrode head 2, can be designed with a comparatively small cross section or diameter.

According to FIG. 1, a largest cross section of the electrode head 2 has an external diameter of 1.8 mm; an external diameter of the electrode pin is 0.5 mm.

A further advantage of the use of drawn wire for producing the electrode rod 4 becomes clear when viewing a material loss, illustrated dashed in FIG. 1, which would arise if the electrode 1 were to be turned from solid material in a conventional way.

Furthermore, the electrode rod 4 has along the overall length thereof a surface structure optimized by means of longitudinal grooves 8, which have already been introduced by a drawing tool when drawing the wire for producing the electrode rod 4. In this case, an average roughness in the direction of the longitudinal axis 10 of the electrode rod 4 is lower than transversely with respect to the longitudinal axis 10.

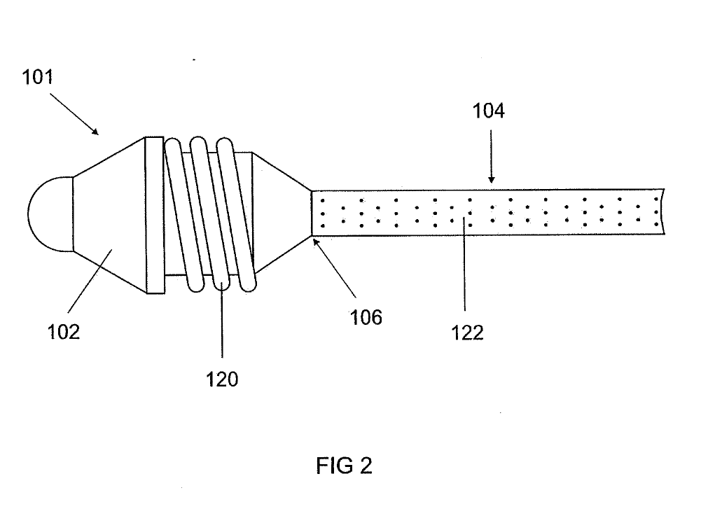

Differing from the first exemplary embodiment according to FIG. 1, FIG. 2 shows a schematic illustration of a second exemplary embodiment of an electrode 101 having a grid structure, optimized by doping, of an electrode rod 104 in a lateral view.

The electrode 101 additionally has a spiral 120, by which a massive electrode head 102 of the electrode 101 is encompassed.

The electrode head 102 extends from a connecting point 106, arranged on the right in FIG. 2, at which the electrode head 102 is joined to the electrode rod 104 via a butt welding method, as far as a hemispherical electrode head tip illustrated on the left in FIG. 2. The spiral 120 is shaped in a separate process, subsequently slipped onto the electrode head 102 and fixed to the electrode head 102 by laser welding or laser welding spots arranged at end sections of the spiral 120. As an alternative to this, the spiral 120 can be fixed to the electrode head 102 with a less expensive resistance welding method. The electrode head 102 and the spiral 120 consist of tungsten with a concentration of contaminants of less than 10 ppm.

The electrode rod 104 consists of drawn tungsten wire. Differing from the electrode rod (cf. 4, FIG. 1) of the first exemplary embodiment according to FIG. 1, this wire does not have a separately optimized surface structure in the form of longitudinal grooves (cf. 8, FIG. 1). However, the electrode rod 104 also has in the radial edge region and in the inner region the optimized microstructure mentioned in the first exemplary embodiment according to FIG. 1, on account of the drawing process of the wire.

Differing from the first exemplary embodiment according to FIG. 1, the electrode rod 104 has over its entire length doping 122 with potassium—symbolized in FIG. 2 by dots. In order to obtain the most homogeneously doped wire, the potassium has been introduced into a preceding powder-metallurgical fabrication step. The concentration of the potassium is 70 ppm, by which means void formation in an area of the connecting point 106 during the butt welding is limited to an acceptable extent.

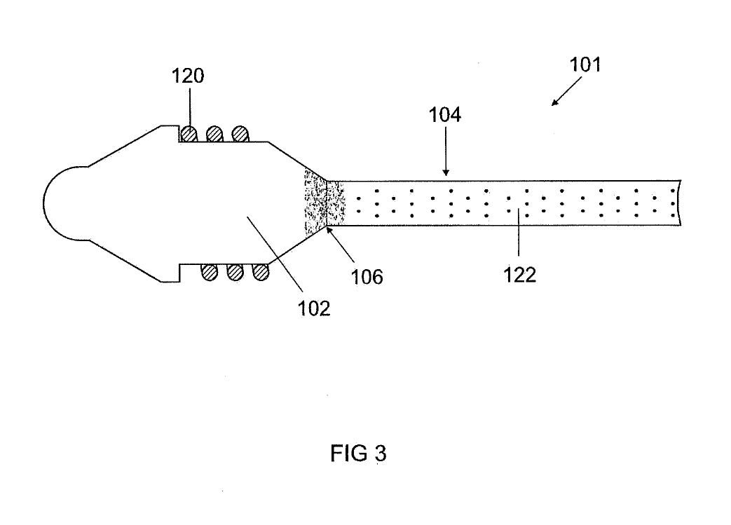

FIGS. 3 to 5 show micrographs of the electrode 101 doped in accordance with the invention from the second exemplary embodiment according to FIG. 2 in order to illustrate the structure thereof.

FIG. 3 shows the electrode head 102 turned out of solid material with a diameter of 1.8 mm. The wire of the electrode rod 104 has been drawn down to a diameter of 0.5 mm in a standard drawing process, consists of tungsten and has been homogeneously provided with the structure-stabilizing potassium doping 122 (cf. FIG. 2). In the area of the connecting point 106 between the electrode head 102 and the electrode rod 104, a melt zone having modified structural properties is formed as a consequence of the butt welding.

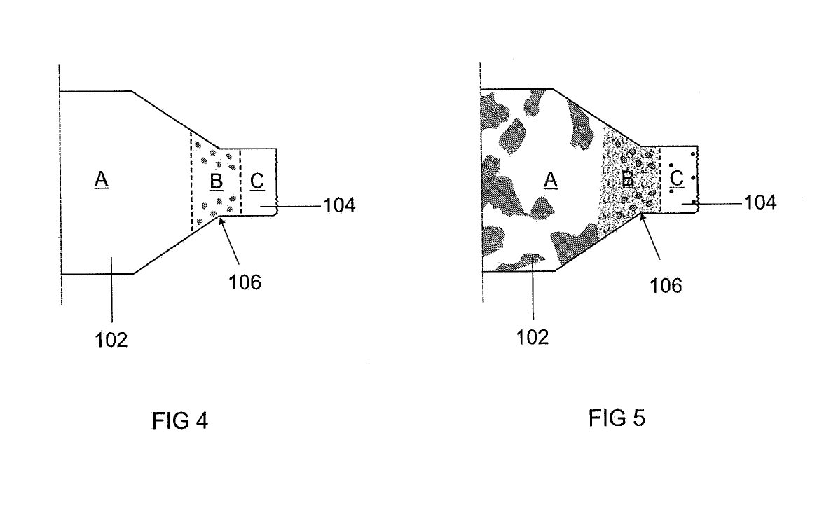

FIG. 4 shows the area of the ground section according to FIG. 3 around the connecting point 106 in a polished state.

Here, voids illustrated as black spots can be seen particularly well in a radial outer region of a region B of the welding or the zone of thermal influence.

FIG. 5 shows an enlarged and additionally etched area of the ground section according to FIGS. 3 and 4 around the connecting point 106.

Three areas A, B and C that can be delimited from one another coarsely by dash-dotted lines can be seen. In the area A of the electrode head 102, which adjoins the area B of the connecting point 106, large polygonal grains have been formed. In the area B, in which there was a higher influence of heat during the butt welding, recrystallization of the grains took place. In the area C of the doped electrode rod 104 adjoining the area B, the grains of the structure have predominantly been stretched and toothed. On account of the doping of the electrode rod 104 with 70 ppm potassium, blackish cavities or voids can additionally be seen in the radial outer region of the area B in the area of the welding.

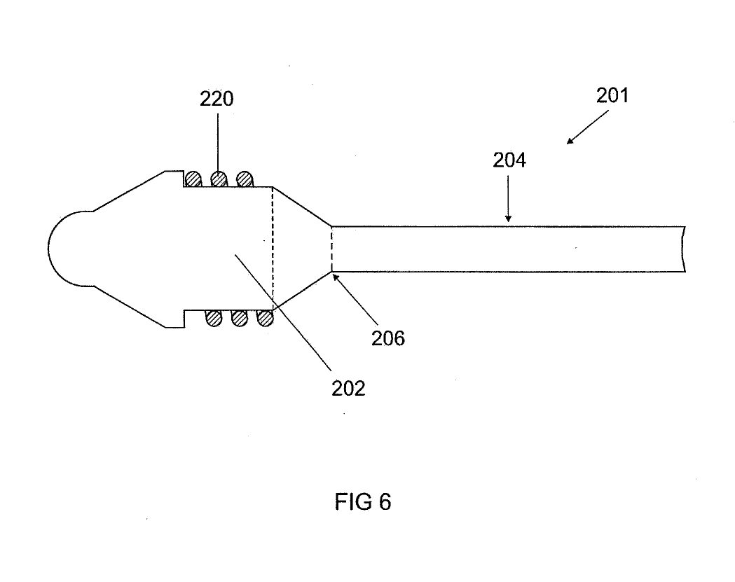

To illustrate the difference in the structure of doped and non-doped electrode rods, FIGS. 6 to 8 show micrographs of a third exemplary embodiment of an electrode 201 according to the invention, of which the electrode rod 204, as distinct from the second exemplary embodiment shown in FIGS. 2 and 5, is not doped and consists of highly pure tungsten. Here, the basic geometric dimensions of the electrode 201 are the same as those of the electrode of the second exemplary embodiment according to FIG. 2.

The complete micrograph of the electrode 201 with non-doped electrode rod 204, shown in FIG. 6, has few easily detectable differences from the corresponding micrograph of the electrode 101, which has a doped electrode rod 104 (cf. FIG. 3).

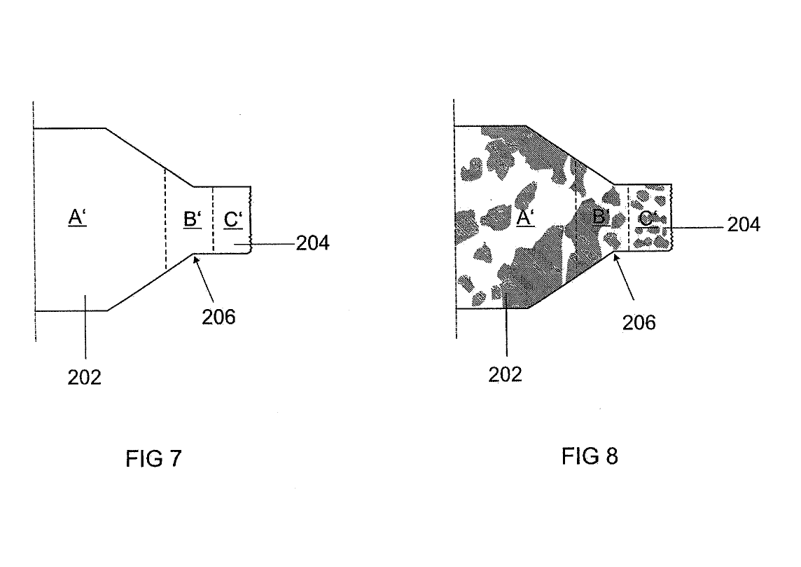

The differences become clear only when FIGS. 7 and 8 are considered.

FIG. 7 shows an enlarged detail from a polished micrograph of the ground section according to FIG. 6. As opposed to the second (doped) exemplary embodiment (cf. FIG. 4), no black hollows can be seen, which illustrates the fact that in an area B′ of the weld connecting point 206 of the electrode rod 204 and the electrode head 202, no cavities or voids are formed.

FIG. 8 shows an enlarged and additionally etched area of the ground section according to FIG. 7 around the connecting point 206.

Analogous to FIG. 5, in this case three areas A′, B′ and C′ that can be delimited roughly from one another by dash-dotted lines can be seen. In the areas A′ of the electrode head 202 and C′ of the electrode pin 204 adjacent to the area B′ of the weld, polygonal grains have been formed. In the area B′, in which there was a higher influence of heat during the butt welding, recrystallization of the grains took place. FIGS. 3 to 8 thus illustrate the fact that doping of an electrode rod with subsequent welding and intense action of heat on the doped material can lead to void formation and/or to weakening of the connecting point. A concentration of the doping must therefore be optimized. Trials showed that, taking account of a maximum doping concentration of 70 to 100 ppm in the electrode rod, the connecting point is not subjected to any loss of strength.

In all the exemplary embodiments shown, at least one of the structures (grid structure, microstructure, surface structure) is optimized. This optimization in all the exemplary embodiments extends not just to a section of the electrode rods 4; 104; 204 but to the entire length of these electrode rods 4; 104; 204. It is pointed out that the invention also claims electrode rods in which a structure of only one section of the electrode rod is optimized. This section can additionally coincide physically with a guide section which, in an installed state of the electrode, is led through a wall of the discharge vessel of the gas discharge lamp or is fused into said wall or which is encompassed by said wall.

From the prior art, diameter ratios up to about 3.8 are known. For example, conventional electrodes have the following diameters: electrode head=1.5 mm/electrode pin=0.4 mm; which corresponds to a diameter ratio of 3.6.

Independently of the exemplary embodiments shown, by contrast, by using the electrode rod or section of the electrode rod optimized in accordance with the invention, greater diameter ratios of about 5.0 can be achieved. An example: electrode head=1.5 mm/electrode pin=0.3 mm, which corresponds to a diameter ratio of 5.0.

The applicant reserves the right to direct a patent application to a method for producing an electrode rod of which the structure is optimized in this way.

This method according to the invention, which can be applied to all the exemplary embodiments, for fabricating an electrode for a gas discharge lamp, in particular for a high-pressure or extremely high-pressure gas discharge lamp, comprises at least one of the following steps in order to increase the strength of at least one section of an electrode rod or of the entire electrode rod:
“optimizing a grid structure,”
or “optimizing a microstructure”,
or “optimizing a surface structure”,
   at least of the section of the electrode rod or of the entire electrode rod.

The step “optimizing the grid structure” is preferably carried out by doping the section of the electrode rod or the entire electrode rod or a semifinished product of the electrode rod with a dopant. The doping is preferably carried out by adding dopant in a powder-metallurgical method step. Particularly preferably, the dopant is potassium or at least has potassium. The concentration of the dopant is preferably less than about 100 ppm; particularly preferably it is less than about 70 ppm.

The step “optimizing the microstructure” or the step “optimizing the surface structure” is preferably carried out by drawing or rolling a semifinished product of the electrode rod to form a wire. The optimized surface structure preferably has a roughness which is lower in the longitudinal direction than in the transverse direction. Particularly preferably, the surface structure is optimized by longitudinal grooves. The microstructure is preferably optimized in a radial edge region of the semifinished product or of the wire by means of finer granulation or a compacted structure.

1-15. (canceled)

16. An electrode for a gas discharge lamp having a massive electrode head and an electrode rod connected thereto, which has a guide section which can be led through a wall of a discharge vessel of the gas discharge lamp or can be fused into said wall or can be encompassed by said wall, characterized in that the grid structure of at least one section of the electrode rod has doping, and wherein at least one section of the electrode head consists of highly pure tungsten, and wherein a concentration of a contaminant is less than 10 ppm.

17. The electrode as claimed in claim 16, wherein the doping has potassium.

18. The electrode as claimed in claim 16, wherein a concentration of the doping is at most 100 ppm.

19. The electrode as claimed in claim 16, wherein the electrode rod consists predominantly of tungsten.

20. The electrode as claimed in claim 16, wherein the section and the guide section coincide physically.

21. A gas discharge lamp having a discharge vessel and having two electrodes arranged approximately diametrically therein, wherein at least one of the electrodes is an electrode as claimed in claim 16.

22. The gas discharge lamp as claimed in claim 21, wherein the guide section is arranged in a sleeve which is fused or inserted into the wall.
